(19) United States
(12) Patent Application Publication
(10) Pub. No.: US 2026/0318603 A1
(43) Pub. Date: Oct. 15, 2026

(54) APPARATUS AND METHOD FOR PREVENTING OXIDATION SCALE FUSION BONDING INSIDE A HEATING FURNACE

(71) Applicant: Hyundai Steel Company, Incheon (KR)

(72) Inventors: Chang Hyun Wee, Incheon (KR); Tae Young Lee, Incheon (KR); Won Ki Jin, Incheon (KR); Hong Kil Moon, Incheon (KR); Joong Ki Hwang, Incheon (KR)

(21) Appl. No.: 19/684,647

(22) Filed: May 21, 2026

Related U.S. Application Data
(63) Continuation of application No. PCT/KR2024/017229, filed on Nov. 5, 2024.

(30) Foreign Application Priority Data
Nov. 23, 2023 (KR) 10-2023-0164634

(51) Int. Cl. F27D 25/00; F27D 3/02; F27D 19/00

(52) U.S. Cl. CPC F27D 25/00; F27D 3/024; F27D 2019/004; F27M 2001/02

(57) ABSTRACT

The present disclosure provides: a heating furnace apparatus for heating a material to be heated while supporting same by a skid beam and transferring same; and a method for preventing oxidation scale fusion bonding in a heating furnace using same. The heating furnace apparatus comprises a skid rider disposed on one side of a skid beam so as to be in contact with the lower surface of a material to be heated, wherein the height of the skid rider is 75 mm to 100 mm, and/or the area of the top surface of the skid rider is 7,500 mm² to 10,000 mm².

### CROSS-REFERENCE TO THE RELATED APPLICATIONS

This application is a continuation of International Application No. PCT/KR2024/017229 filed Nov. 5, 2024, which claims the benefit of Korean Patent Application No. 10-2023-0164634, filed Nov. 23, 2023, in the Korean Intellectual Property Office, the entire contents of which applications are incorporated herein by reference.

### FIELD

The present disclosure relates to an apparatus and method for preventing oxidation scale fusion bonding inside a heating furnace, and more particularly, to an apparatus and method capable of suppression of oxidation scale fusion bonding on an upper portion of a skid rider.

### BACKGROUND

In general, a hot rolling process heats materials such as slab, bloom, and billet, and proceeds through rough rolling and finish rolling, followed by cooling, straightening, and the like, to produce rolled steel plate, bar stock, wire rod, and the like. The materials are heated to a range of 1100 to 1300° C. inside a heating furnace prior to rolling to reduce the load during rolling and to obtain the mechanical properties required during the cooling process. The heating furnace that heats the materials to the rolling temperature is divided into a preheating zone, a heating zone, a soaking zone, and the like, and a certain amount of fuel is continuously supplied to each zone to maintain the required temperature. The material charged into the heating furnace is conveyed from the charging point to the extraction point, and upon reaching the extraction point, the material is maintained in a heated state at a temperature sufficient for rolling.

The configuration of a conventional heating furnace will be briefly described with reference to FIG. 1. The interior of a general heating furnace comprises a skid beam 2 and a skid rider 8 that support a material to be heated 1 having a rectangular bar shape, and burners for raising the temperature, and the material to be heated 1 inside the heating furnace comes into direct contact with the skid rider 8. During this process, as shown in FIG. 3, the material to be heated 1 comes into contact with the oxidation scale a that has undergone fusion bonding on the upper end of the skid rider 8, causing surface defects b to occur on the bottom surface of the material to be heated 1.

Conventionally, the operation of the heating furnace was periodically stopped to remove the fusion-bonded scale formed on the top surface of the skid rider or to replace the skid rider, and after the heating furnace was stopped, workers directly removed the fusion-bonded scale or proceeded with replacement of the skid rider. Such interruptions to heating furnace operation became a factor in reduced operating rates and productivity. In particular, when surface quality defects occur on the bottom surface of the material, not only must quality defect materials be addressed, but it is also impossible to take immediate action inside the high-temperature heating furnace to remove the fusion-bonded scale or replace the skid rider; workers must wait until the temperature has decreased before taking action, resulting in significant production losses.

Accordingly, attempts have been made to manufacture the skid rider from a chromium-based heat-resistant alloy in order to improve its corrosion resistance; however, the chromium-based material reacts with iron oxide (FeO), which is the main component of scale, at high temperatures over a long period of time, generating FeO—Cr₂O₃ oxide on the surface of the skid rider, thereby promoting fusion bonding after oxidation scale formation. Furthermore, when attempting to prevent the accumulation of oxidation scale on the top surface of the rider member by implementing an inclined shape for the skid rider, there is a limitation in dispersing the stress caused by the load of the material to be heated, and thus this approach is not effective in preventing fusion bonding of oxidation scale.

### SUMMARY

In one aspect, the present disclosure is directed to solving such conventional problems and has an object of preventing oxidation scale fusion bonding on top of the skid rider and reducing surface defects occurring on the bottom surface of the material to be heated. However, such problems are illustrative, and the scope of the present disclosure is not limited thereby.

According to one aspect of the present disclosure, a heating furnace apparatus is provided.

In one aspect, a heating furnace apparatus, comprising: a) a skid beam; and b) a skid rider configured to contact a material to be heated, wherein a height of the skid rider is 75 mm to 100 mm, and/or a top surface area of the skid rider is 7,500 mm² to 10,000 mm².

In preferred systems, a height of the skid rider is 75 mm to 100 mm, and a top surface area of the skid rider is 7,500 mm² to 10,000 mm².

In an aspect, the heating furnace apparatus is a heating furnace apparatus that heats a material to be heated while supporting and conveying the material to be heated with a skid beam, the heating furnace apparatus comprising a skid rider disposed on one side of the skid beam and formed to contact the bottom surface of the material to be heated, wherein the height of the skid rider is 75 mm to 100 mm, and/or the top surface area may be 7,500 mm² to 10,000 mm². In certain preferred systems, a height of the skid rider is 75 mm to 100 mm, or a top surface area of the skid rider is 7,500 mm² to 10,000 mm².

In certain preferred systems, a height of the skid rider is 75 mm to 100 mm, and a top surface area of the skid rider is 7,500 mm² to 10,000 mm².

According to one embodiment of the above apparatus, the top surface temperature of the skid rider may be controlled to a temperature at or below the melting point of Fe₂SiO₄.

According to one embodiment of the above apparatus, scale detachment from the bottom surface of the material to be heated and deposition onto the top surface of the skid rider may be suppressed.

According to one embodiment of the above apparatus, multiple skid riders may be arranged along the centerline of the skid beam. The centerline may refer to a centerline in a direction parallel to the conveying direction of the material to be heated or may refer to a centerline in the longitudinal direction of the skid beam.

According to another aspect of the present disclosure, a method of preventing oxidation scale fusion bonding using the heating furnace apparatus is provided.

The method may involve controlling the lower atmosphere temperature to be 25° C. to 50° C. lower than the upper atmosphere temperature of the material to be heated.

According to one embodiment, as the lower atmosphere temperature of the material to be heated decreases, the top surface temperature of the material to be heated may be controlled to be lower.

According to one embodiment, the lower atmosphere temperature of the material to be heated may be controlled to 1,230° C. or below.

According to one embodiment, the lower atmosphere temperature of the material to be heated may be controlled by adjusting the gas flow rate of the burner of the heating furnace.

In a further aspect, a method of preventing or reducing fusion bonding of oxidation scale in a heating furnace is provided, the method suitably comprising:
a) providing a heating furnace comprising: i) a skid beam; and ii) a skid rider configured to contact a material to be heated, wherein a height of the skid rider is 75 mm to 100 mm, and/or a top surface area is 7,500 mm² to 10,000 mm²;
b) controlling a lower atmosphere temperature of the heating furnace to be 25° C. to 50° C. lower than an upper atmosphere temperature of the material to be heated.

In certain preferred systems of the above method, a height of the skid rider is 75 mm to 100 mm, or a top surface area of the skid rider is 7,500 mm² to 10,000 mm².

In certain preferred systems of the above method, a height of the skid rider is 75 mm to 100 mm, and a top surface area of the skid rider is 7,500 mm² to 10,000 mm².

In aspects of the present furnace and methods, the furnace may further comprises a material to be heated that is a slab, bloom, and/or billet.

In aspects of the present furnace and methods, the furnace may further comprise a material to be heated that comprises steel composition, metal alloy composition and/or a steel precursor composition.

As referred to herein, the atmosphere temperature is the temperature of the environment or material inside a heating furnace or heat-treating furnace.

According to the embodiments of the present disclosure made as described above, quality defects may be reduced due to the reduction of surface defects on the material to be heated, and cost reduction may be achieved due to a decrease in the replacement cycle of the skid rider.

Of course, the scope of the present disclosure is not limited by these effects.

### BRIEF DESCRIPTION OF THE DRAWINGS

FIG. 1 is a schematic diagram showing a skid beam and a skid rider in a general heating furnace.

FIG. 2 is an enlarged perspective view of FIG. 1.

FIG. 3 (includes FIGS. 3(a) and 3(b)) are photographs observing oxidation scale (a) on the top end of the skid rider and surface defects (b) on the material to be heated in a conventional heating furnace.

FIG. 4 (includes FIGS. 4(a) and 4(b)) are schematic diagrams showing the pattern in which scale undergoes fusion bonding on the top surface of the skid rider in a conventional heating furnace.

FIG. 5 (includes FIGS. 5(a-1), 5(a-2), 5(a-3), 5(a-4), 5(b)) shows the change in top surface temperature according to the change in height of the skid rider in accordance with an embodiment of the present disclosure.

FIG. 6 (includes FIGS. 6(a) and 6(b)) is a schematic diagram showing the change in shape of the skid rider according to (a) the conventional art and (b) an embodiment of the present disclosure.

FIG. 7A and FIG. 7B show the results of stress distribution analysis of the skid rider due to the reduction in the top surface area of the skid rider according to FIG. 6.

FIG. 8 (includes FIGS. 8(a) and 8(b)) shows the results of temperature analysis of the material to be heated according to temperature control of the lower atmosphere temperature of the heating zone within the heating furnace in accordance with an embodiment of the present disclosure.

FIG. 9 (includes FIGS. 9(a) and 9(b)) are photographs comparing the top surfaces of the skid riders according to the Comparative Example and the embodiment of the present disclosure.

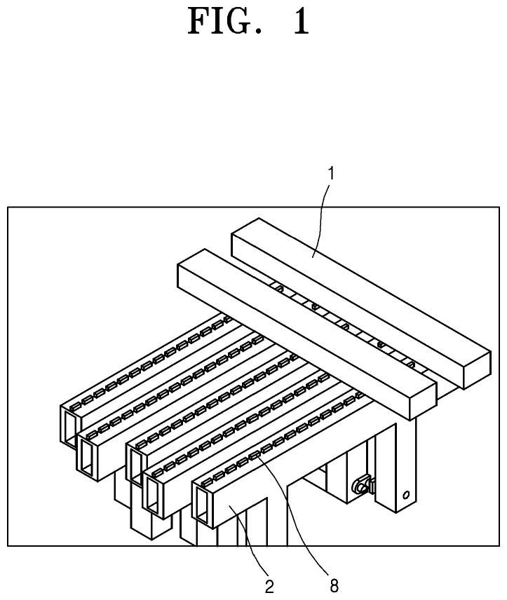

### DETAILED DESCRIPTION

Hereinafter, various embodiments of the present disclosure will be described in detail with reference to the accompanying drawings. The embodiments of the present disclosure are provided to more completely explain the present disclosure to those skilled in the art, and the following embodiments may be modified in various other forms, and the scope of the present disclosure is not limited to the following embodiments. Rather, these embodiments are provided to make the present disclosure more faithful and complete, and to fully convey the spirit of the present disclosure to those skilled in the art. In addition, the thickness or size of each layer in the drawings is exaggerated for convenience and clarity of description.

Hereinafter, a continuous heating furnace comprising a skid rider according to an embodiment of the present disclosure will be described.

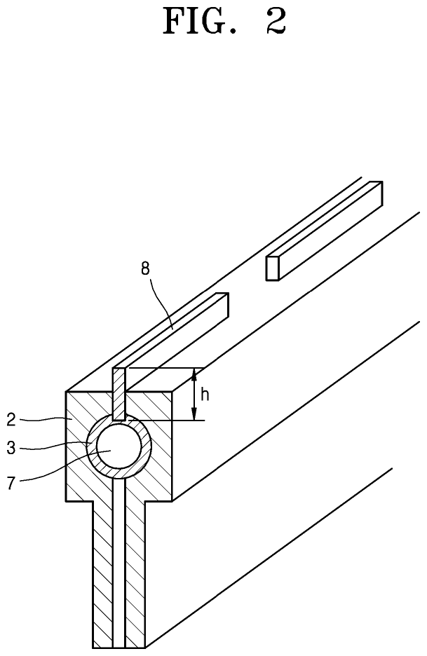

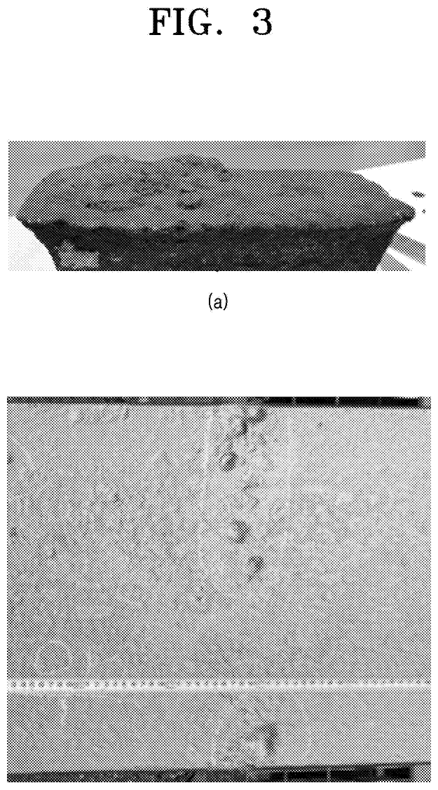

FIG. 2 shows the appearance of a general continuous heating furnace. Referring to FIG. 2, the continuous heating furnace is provided with a walking-type skid beam 2, by which the material to be heated is raised, advanced, and lowered for conveyance in the conveying direction. The skid beam 2 is provided with a skid pipe 3 through which cooling water 7 circulates internally, and a skid rider 8 made of insulation material is fixedly supported on the upper side of the skid pipe 3.

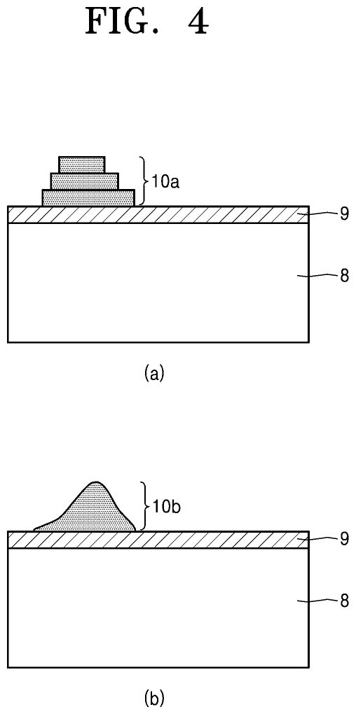

The pattern in which oxidation scale undergoes fusion bonding on the top surface of the skid rider in such a conventional heating furnace is illustrated in FIG. 4.

Referring to FIG. 4, (a) shows the scale formation process due to physical bonding, and (b) shows the scale formation process due to chemical bonding. A chromium oxide (Cr₂O₃) oxide layer 9 is formed on the surface of the skid rider 8, and oxidation scale 10 is formed on top of the oxide layer. In the case of FIG. 4, (a) primary oxidation scale is deposited on the top surface of the skid rider, and under high temperature and high pressure caused by the load of the material to be heated, the scale undergoes plastic deformation, and as secondary and tertiary oxidation scale are additionally deposited, physical fusion bonding occurs through diffusion.

In the case of FIG. 4, (b) primary oxidation scale is deposited on the top surface of the skid rider, and chemical fusion bonding occurs due to the binding effect of low melting point elements under high temperature and high pressure. Representatively, fusion bonding occurs at temperatures exceeding the melting point of 1,173° C. of the low melting point oxide Fe₂SiO₄.

As measures for removing and reducing such oxidation scale, the present disclosure proposes an apparatus and method for: (1) controlling the top surface temperature of the skid rider by changing the height of the skid rider; (2) minimizing the area of the skid rider on which oxidation scale can be deposited; and (3) performing temperature control of the lower atmosphere temperature of the heating zone within the heating furnace.

Specifically, according to one aspect of the present disclosure, a heating furnace apparatus is provided in which the height of the skid rider is 75 mm to 100 mm and the top surface area is 7,500 mm² to 10,000 mm². This is intended to control the top surface temperature of the skid rider to below the melting point of Fe₂SiO₄, which is a low melting point oxide, and to minimize the area of the skid rider on which oxidation scale can be deposited.

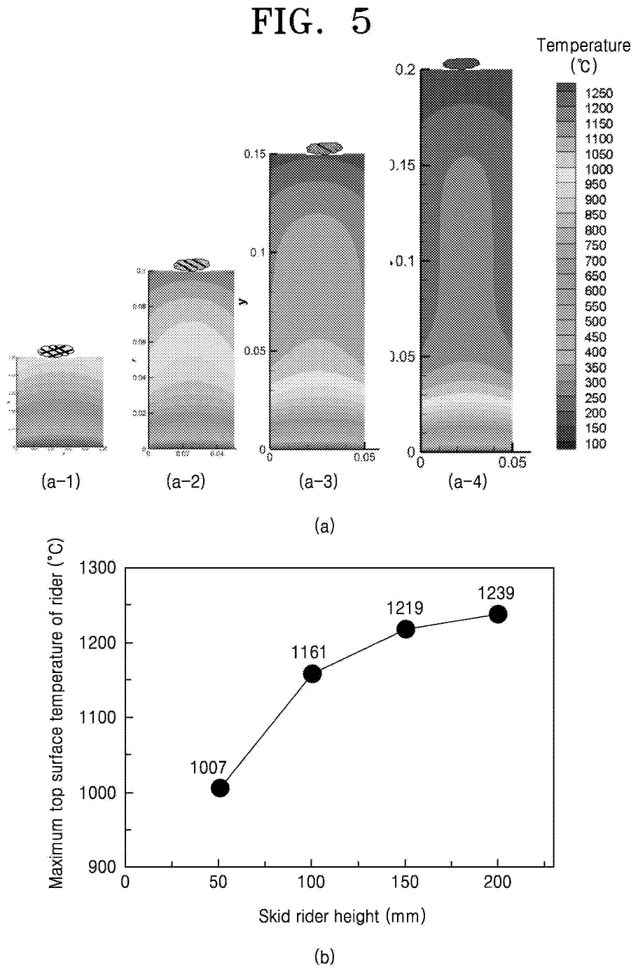

FIG. 5 shows the change in top surface temperature according to the change in height of the skid rider in accordance with an embodiment of the present disclosure.

In FIG. 5, (a) shows the temperature change according to the height of the skid rider, indicating the temperatures at (a-1) 50 mm, (a-2) 100 mm, (a-3) 150 mm, and (a-4) 200 mm. It can be seen that as the height of the skid rider decreases, the top surface temperature of the skid rider due to skid beam cooling decreases. The scale at a height of 200 mm is elongated and undergoes fusion bonding, whereas the scale at a height of 50 mm is fractured, thereby making it possible to prevent oxidation scale fusion bonding.

In FIG. 5, (b) is a graph showing the results according to (a), and when the height of the skid rider is maintained at 100 mm or less, the top surface temperature can be designed to be 1,173° C. or less, which is below the melting point of the low melting point oxide, thereby reducing oxidation scale fusion bonding. Fundamentally, inducing a reduction in scale fusion bonding decreases the bonding force of the scale itself, which can facilitate its removal. Preferably, it is advisable to maintain the height of the skid rider at 75 mm or more. At a height below 75 mm, the top surface temperature of the skid rider may become too low to sufficiently heat the material to be heated.

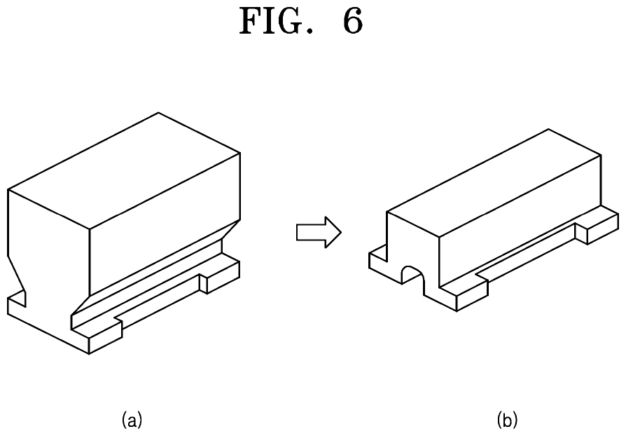

FIG. 6 is a schematic diagram showing the change in shape of the skid rider according to (a) the conventional art and (b) an embodiment of the present disclosure.

Referring to FIG. 6, the skid rider according to (b) an embodiment of the present disclosure is designed with a lower height compared to the conventional skid rider, and the top surface area has been reduced. In addition, the bottom surface of the body may be designed in an arch-shaped configuration in order to distribute the stress applied from above to both ends of the lower portion by an amount corresponding to the reduced top surface area. In FIG. 6, for example, the top surface area may be reduced from (a) the existing 12,000 mm² to (b) 7,500 mm² to 10,000 mm². Accordingly, the probability and extent of oxidation scale deposition on the top surface of the skid rider can be reduced.

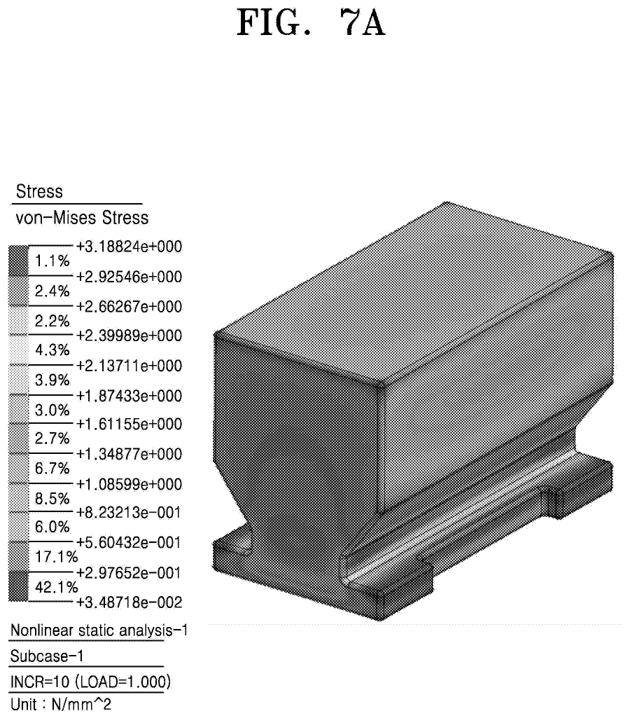

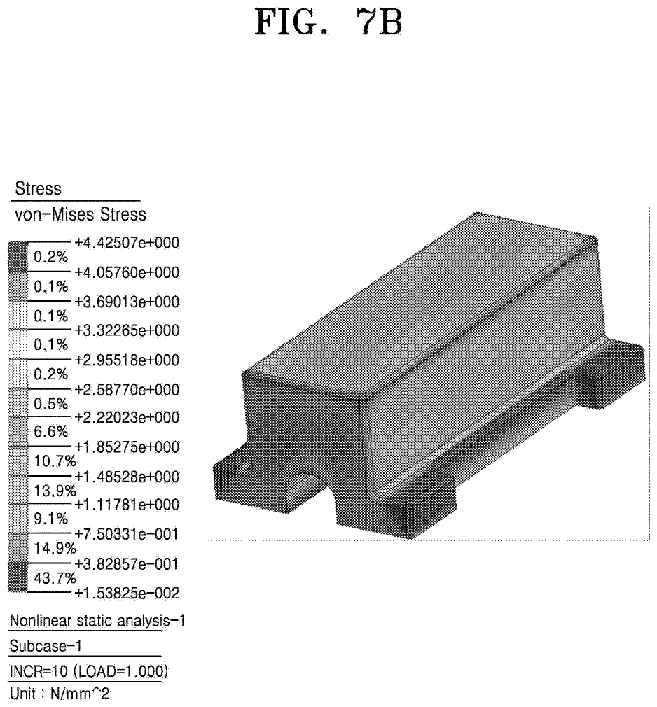

FIG. 7A and FIG. 7B show the results of stress distribution analysis of the skid rider due to the reduction in the top surface area of the skid rider according to FIG. 6.

As a result of the stress analysis of FIG. 7A and FIG. 7B, in the case of FIG. 7A, stress is concentrated overall in the center connecting the upper and lower portions of the skid rider, whereas in the case of FIG. 7B, stress can be distributed to both ends of the lower portion due to the reduction in cross-sectional area of the top surface of the skid rider and the arch-shaped body structure. The average stress increased slightly from 1.54 MPa (FIG. 7A) to 2.24 MPa (FIG. 7B), but the effect on the function of the skid rider in supporting and moving the material and on the quality of the material to be heated was determined to be negligible.

In this manner, by reducing the top surface area of the skid rider to 7,500 mm² to 10,000 mm², the suppression of scale that detaches from the bottom surface of the material to be heated and is deposited on the top surface of the skid rider can be achieved.

According to another aspect of the present disclosure, a method of preventing oxidation scale fusion bonding using the heating furnace apparatus described above is provided.

Specifically, fusion bonding of oxidation scale can be prevented by controlling the lower atmosphere temperature to be 25° C. to 50° C. lower than the upper atmosphere temperature of the material to be heated. As the lower atmosphere temperature of the material to be heated decreases, the temperature of the top surface of the material to be heated can be controlled to be lower.

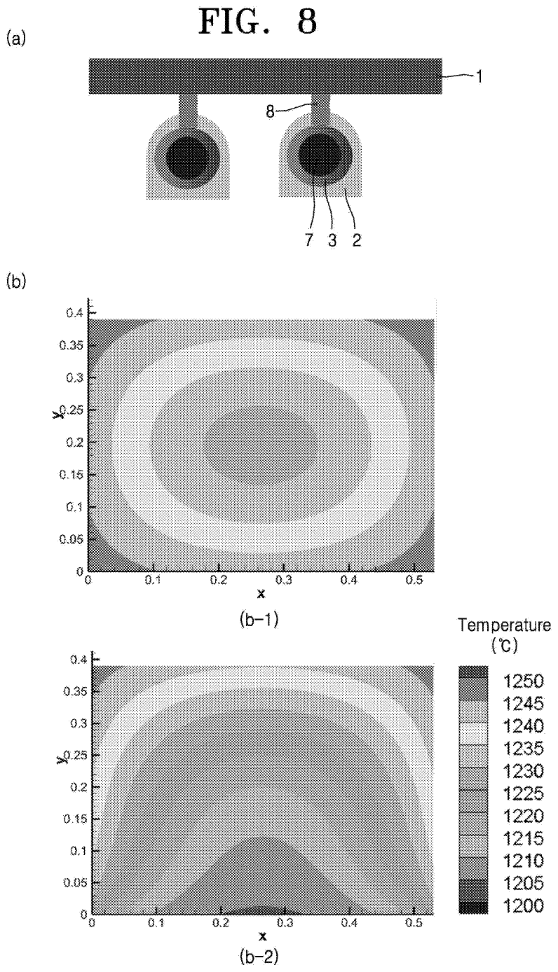

FIG. 8 shows the results of temperature analysis of the material to be heated according to temperature control of the lower atmosphere temperature of the heating zone within the heating furnace in accordance with an embodiment of the present disclosure. For example, in FIG. 8, (a) by controlling the lower atmosphere temperature to be lower than 1,230° C. relative to the upper atmosphere temperature, the temperatures of the lower portions of the skid rider 8 and the material to be heated 1 are reduced, thereby lowering the temperature of the oxidation scale deposited on the top surface of the skid rider 8. Through this, oxidation scale fusion bonding can be prevented.

In FIG. 8, (b-1) shows the temperature of the material to be heated 1 when the upper and lower atmosphere temperatures of the heating zone are both controlled equally at 1,250° C., and it can be confirmed that the temperature is symmetrically distributed in the y-axis direction and the temperatures of the top surface and bottom surface are identical. (b-2) shows the case where the upper atmosphere temperature of the heating zone is controlled at 1,250° C. and the lower atmosphere temperature is controlled at 1,200° C., and it can be confirmed that the temperature of the bottom surface of the material to be heated 1 decreases to near 1,200° C., and the temperature of the top surface of the material to be heated 1 also decreases to 1,240° C. to 1,245° C. compared to (b-1).

Such lower atmosphere temperature of the material to be heated can be appropriately controlled by adjusting the gas flow rate supplied to the burner that provides a heat source to the heating furnace. There may be multiple burners, and a first burner may be arranged at the upper portion of the heating furnace, and a second burner may be arranged at the lower portion of the heating furnace. The lower atmosphere temperature can be controlled by supplying a second gas flow rate to the second burner that is less than the first gas flow rate supplied to the first burner.

### EXPERIMENTAL EXAMPLES

Hereinafter, preferred experimental examples are presented to aid in understanding the present disclosure. However, the following experiments are only intended to aid in understanding the present disclosure, and the present disclosure is not limited by the following experimental examples.

Table 1 below shows the skid rider shape and heating furnace operating conditions according to the Comparative Example and the Example.

TABLE 1

| | | | | | Comparison of |
|---|---|---|---|---|---|
| | | | | | Example vs. |
| | Comparative | | | | Comparative |
| Category | Example | | Example | | Example |
| Skid rider | Heat-resistant | | Heat-resistant | | Identical |
| material | alloy | | alloy | | |
| Skid rider height | 120 | mm | 75 | mm | 25.0% |
| Skid rider top | 80 × 150 | mm² | 50 × 150 | mm² | 37.5% |
| surface area | | | | | reduction |
| Heating furnace | 1,250 | °C | 1,265 | °C | 15 °C increase |
| upper temperature | | | | | |
| (heating zone) | | | | | |
| Heating furnace | 1,250 | °C | 1,230 | °C | 20 °C reduction |

lower temperature
(heating zone)

The Comparative Example and the Example were applied to heat materials, after which 10 skid riders, each were randomly sampled, and the maximum thickness of the fused scale was measured. This is because the thicker the scale, the higher the probability that the material surface becomes indented, and surface defects occur. The results are shown in Table 2.

TABLE 2

| Skid Rider No. | Comparative Example | Example |
|---|---|---|
| 1 | 2.1 | 0.4 |
| 2 | 0.5 | 0.2 |
| 3 | 2.3 | 1.1 |
| 4 | 4.2 | 0.3 |
| 5 | 6.5 | 0.5 |
| 6 | 2.7 | 0.2 |
| 7 | 3.4 | 0.3 |
| 8 | 5.4 | 0.1 |
| 9 | 2.4 | 0.6 |
| 10 | 0.2 | 0.7 |
| Average | 2.53 | 0.24 |

In the case of the Comparative Example, the average thickness of the fused scale was 2.53 mm, and in the case of the Example, a result of 0.24 mm was confirmed.

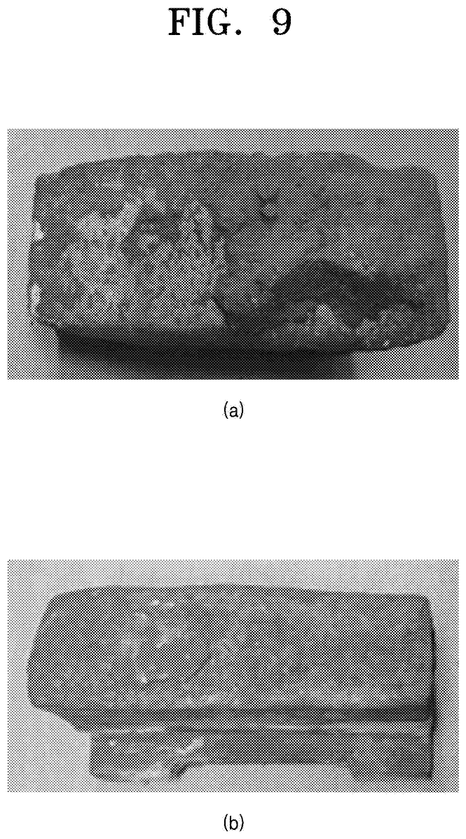

FIG. 9 is a photograph comparing the top surfaces of the skid riders according to the Comparative Example and the embodiment of the present disclosure. Through this, it was confirmed that in the Example, scale was almost not fused, and it was confirmed that only deposited scale with a thin thickness existed, as a small amount of deposited oxidation scale was compressed by the material.

According to the embodiment of the present disclosure as described above, quality defects are reduced due to the reduction of surface defects on the material to be heated, and cost reduction is possible due to the reduction of the replacement cycle of the skid rider.

Although the present disclosure has been described with reference to the embodiments shown in the drawings, this is merely illustrative, and those skilled in the art will understand that various modifications and equivalent other embodiments are possible therefrom. Therefore, the true technical scope of protection of the present disclosure is defined by the appended patent claims.

1. A heating furnace apparatus, comprising:
a) a skid beam; and
b) a skid rider configured to contact a material to be heated, wherein i) a height of the skid rider is 75 mm to 100 mm, and/or ii) a top surface area is 7,500 mm² to 10,000 mm².

2. The heating furnace apparatus of claim 1, wherein a top surface temperature of the skid rider is controlled to a temperature equal to or below a melting point of Fe₂SiO₄.

3. The heating furnace apparatus of claim 1, wherein suppression of scale that is detached from the bottom surface of the material to be heated and deposited onto the top surface of the skid rider is achieved.

4. The heating furnace apparatus of claim 1, wherein multiple skid riders are arranged along a centerline of the skid beam.

5. The heating apparatus of claim 1, wherein i) a height of the skid rider is 75 mm to 100 mm, and ii) a top surface area is 7,500 mm² to 10,000 mm².

6. The heating apparatus of claim 1, wherein i) a height of the skid rider is 75 mm to 100 mm, or ii) a top surface area is 7,500 mm² to 10,000 mm².

7. The heating furnace apparatus of claim 1, wherein the skid rider is disposed on one side of the skid beam.

8. The heating furnace apparatus of claim 1 wherein the skid beam and/or skid rider is configured to hold a material to be heated.

9. The heating furnace of claim 1 wherein the furnace further comprises a material to be heated that is a slab, bloom, and/or billet.

10. The heating furnace of claim 1 wherein the furnace further comprises a material to be heated comprises steel composition, metal alloy composition and/or a steel precursor composition.

11. A method of preventing or reducing fusion bonding of oxidation scale in a heating furnace, the method comprising:
a) providing a heating furnace comprising: i) a skid beam; and ii) a skid rider configured to contact a material to be heated, wherein a height of the skid rider is 75 mm to 100 mm, and/or a top surface area is 7,500 mm² to 10,000 mm²;
b) controlling a lower atmosphere temperature of the heating furnace to be 25° C. to 50° C. lower than an upper atmosphere temperature of the material to be heated.

12. The method of claim 11, wherein as the lower atmosphere temperature of the material to be heated decreases, a top surface temperature of the material to be heated is controlled to be lower.

13. The method of claim 11, wherein the lower atmosphere temperature of the material to be heated is controlled to 1,230° C. or less.

14. The method of claim 11, wherein the lower atmosphere temperature of the material to be heated is controlled by adjusting a gas flow rate of a burner of the heating furnace.

15. The method of claim 11, wherein i) a height of the skid rider is 75 mm to 100 mm, and ii) a top surface area is 7,500 mm² to 10,000 mm².

16. The method of claim 11, wherein i) a height of the skid rider is 75 mm to 100 mm, or ii) a top surface area is 7,500 mm² to 10,000 mm².

17. The method of claim 11 wherein the furnace further comprises a material to be heated that is a slab, bloom, and/or billet.

18. The method of claim 11 wherein the furnace further comprises a material to be heated comprises steel composition, metal alloy composition and/or a steel precursor composition.
